(19) United States
(12) Patent Application Publication
(10) Pub. No.: US 2006/0038817 A1
(43) Pub. Date: Feb. 23, 2006

(54) Method and apparatus for representing a three-dimensional topography

(75) Inventor: Boris Langer, Frankfurt/Main (DE)

Correspondence Address: LERNER AND GREENBERG, PA, P O BOX 2480, HOLLYWOOD, FL, 33022-2480, US

(73) Assignee: Diehl Avionik Systeme GmbH

(21) Appl. No.: 11/203,872

(22) Filed: Aug. 15, 2005

(30) Foreign Application Priority Data
Aug. 20, 2004 (DE) 10 2004 040 372.4

(51) Int. Cl. G06T 15/50; G06T 15/60

(52) U.S. Cl. 345/426

(57) ABSTRACT

In a method for two-dimensionally representing a three-dimensional topography, imaging data are ascertained from topography data that describe the three-dimensional topography and from light incidence data that vectorially describe a predetermined light incidence. The topography data contain data of individual surfaces and data relating to the orientation of the individual surfaces. For each individual surface a respective associated texture that describes the display of a pattern is calculated from the data relating to the orientation, the texture is weighted in dependence on the light incidence data, and the two-dimensional image of the three-dimensional topography is composed from the weighted textures as imaging data.

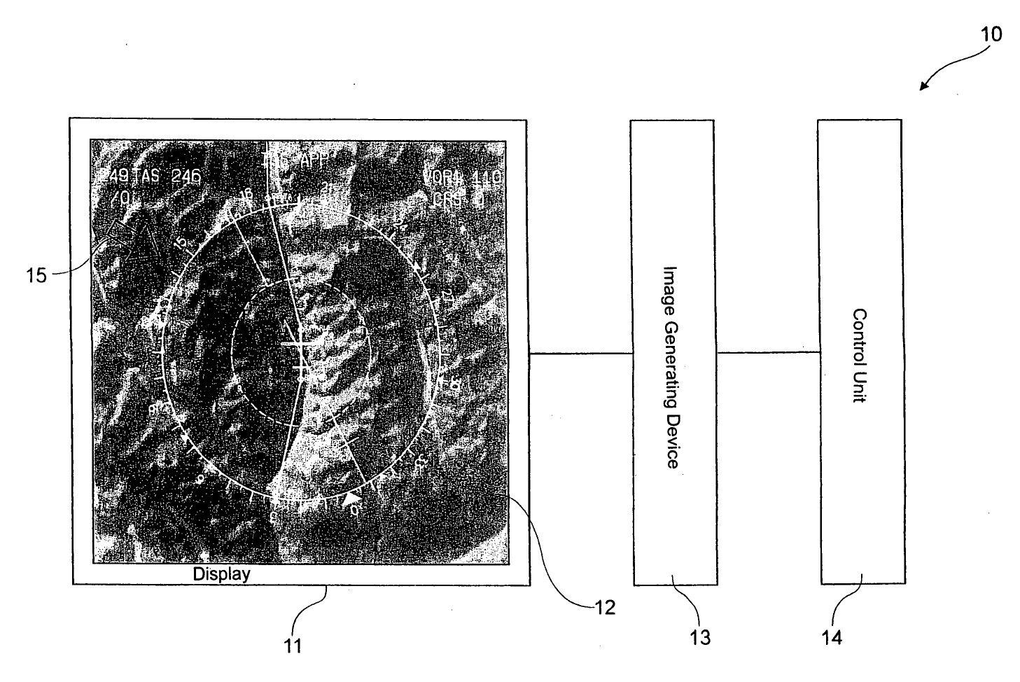

### BACKGROUND OF THE INVENTION

### Field of the Invention

The invention concerns a method of two-dimensionally representing a three-dimensional topography using textures and an apparatus for two-dimensionally representing a three-dimensional topography using textures.

Methods used hitherto for digital map representation depict terrain data by a complex network of triangles. That requires both the calculation of each one of the three corners and also calculation of the respective surface normals for each of the triangles forming the network. Calculation of an illumination and calculation of the projection of the triangles is effected by way of the functions of a graphics card. If however a terrain is to be represented in a high degree of resolution, even modern graphics cards encounter their power limit, when using such calculation methods. That is particularly strikingly apparent when a representation with a high level of resolution is required and the change in representation is to be effected in real time, as is expedient for navigational aids in air travel.

Published, European patent application EP 1 202 222 A1, corresponding to U.S. patent publication No. 20020080,136, proposes a method of real time representation, which involves having recourse to stored textures. This method was developed for representing surfaces in animated video games or in computer-animated cartoon films. For such a use, it is necessary that the persons or objects to be represented are reproduced in as close a relationship with reality as possible, in order very substantially to avoid the impression of artificial representation. In order to ensure lifelike representation of the animation, each calculation step requires the use of a bidirectional reflection distribution function (BRDF) that imitates the natural reflection capability of the respective surface. That calculation method however is complicated and expensive and therefore entails the risk of possible superfluous error sources, in particular for representations in safety-relevant systems such as for navigational aids in air travel.

### SUMMARY OF THE INVENTION

It is accordingly an object of the invention to provide a method and an apparatus for representing a three-dimensional topography which overcomes the above-mentioned disadvantages of the prior art devices and methods this general type, whereby representation of the topography in real time is possible at a lower level of complication and expenditure than in the prior art.

In accordance with the invention, the first-mentioned object in regard to the method is attained by a method of two-dimensionally representing a three-dimensional topography, wherein imaging data are ascertained from topography data which describe the three-dimensional topography and from light incidence data which vectorially describe a predetermined light incidence and the image data are represented as a two-dimensional shaded image. The topography data contain data of individual surfaces and data relating to the orientation of the individual surfaces, and for each individual surface a respective associated texture that describes the display of a pattern is calculated from the data relating to the orientation. The texture is weighted in dependence on the light incidence data, and the two-dimensional image of the three-dimensional topography is composed from the weighted textures as imaging data.

In other words, a three-dimensional topography such as for example a piece of terrain is represented two-dimensionally. For that purpose, at least one texture is calculated from data which characteristically describe the three-dimensional topography and the at least one texture is weighted with a light incidence vector, whereby in particular a level of illumination intensity for the topography is ascertained so that the terrain is two-dimensionally represented in the form of a shaded image.

Imaging data are ascertained from the topography data and the light incidence data, and the two-dimensional image of the three-dimensional topography is composed from the imaging data. By virtue of the simulated lighting that entails a vivid three-dimensionality of the representation, the two-dimensional image appearing three-dimensionally (2.5D-representation), for example in the form of a light-dark representation. For certain uses, such as for example 2.5D-representations, the z-component of the surface normals can be disregarded.

The above-stated method of two-dimensionally representing a three-dimensional topography, for example a piece of terrain, affords a pilot on a navigational display a representation of the terrain relief surrounding him, thereby allowing the pilot an improved assessment of his surroundings. Such a representation is particularly helpful when the pilot is required to navigate at high flight speeds, under poor visual conditions and in low-level flight through difficult terrain, for example in valleys.

A flat terrain model is sufficient for representation of the data as the three-dimensional topography is only to be seen from a bird's eye view and the three-dimensional impression of the representation is produced exclusively by simulated illumination that provides a shaded terrain representation. In such a representation, sides of elevation areas that are away from the light source are represented darker than the sides that are towards the light source.

To describe the terrain to be represented, that is to say the three-dimensional topography, characteristic topography data and in particular cartographic data are used. In cartographic terms it is usual for the surface of the earth to be subdivided without any gap into non-overlapping regions involving the same edge length, wherein each region is uniquely identified by the geographical length and width of its southwesterly corner. Identification of the regions is however also possible by other characteristic points. 300 seconds of arc have proven themselves as the edge length of a region, which in the European area corresponds to approximately 4 nautical miles.

Associated with a respective one of the non-overlapping regions of the surface of the earth is a so-called tile which in tabular form contains the altitude value of each acquired terrain point and the spacing thereof relative to the acquired adjacent terrain points within the depicted region of the surface of the earth or the terrain.

The topography data can be in part directly taken from such tiles and in part calculated from the acquired items of information. For that purpose, for each terrain point that specifies the position of an area of predetermined size, a connecting line to each directly adjacent neighboring terrain point is calculated and the respective normal of the connecting lines is calculated. The mean value of the normals of the connecting lines gives the surface normal of the terrain point, which describes the orientation of the terrain point. In conjunction with the spacing between adjacent terrain points, the surface normals represent the topography data required for the method, which data are stored in a database. The reproduction of the terrain to be described is composed from the individual surfaces defined by the terrain points and the data thereof relating to orientation.

The second object in regard to the apparatus is attained in accordance with the invention by an apparatus for two-dimensionally representing a three-dimensional topography. The apparatus contains a display unit, an image generating device and a control unit. The control unit ascertains imaging data from light incidence data that vectorially describe a predetermined light incidence and from topography data which describe the three-dimensional topography and the imaging data are represented as a two-dimensional shaded image. The topography data contain data of individual surfaces and data relating to the orientation of the individual surfaces, and wherein for each individual surface a respective associated texture which describes the display of a pattern is calculated from the data relating to the orientation in dependence on the light incidence data, the texture is weighted in dependence on the light incidence data, and the two-dimensional image of the three-dimensional topography is composed from the weighted textures as imaging data.

In other words, an apparatus is to be used for two-dimensionally representing a three-dimensional topography, which includes a display unit such as for example a display, an image generating device such as for example a graphics card and a control unit such as for example a computer. The apparatus in accordance with the method of the invention for representing the topography ascertains imaging data and represents therefrom a two-dimensional shaded image. In an advantageous development, the three spatial components of the surface normal are respectively taken from the data relating to the orientation of the individual surfaces or calculated and the imaging data for an individual surface are calculated by forming the scalar product between the surface normal and the light incidence vector. Alternatively the formation of the scalar product is simulated by a blending method for weighted overblending of textures.

The imaging data, in particular the illumination intensity, can be mathematically reproduced by the step of forming the scalar product between surface normal and light incidence vector, in which case the angle between the two vectors describes the level of illumination intensity. The greater the angle the correspondingly weaker is the illumination intensity.

In order to simulate illumination of the terrain to be depicted, light incidence data are used, which are preferably described by the light incidence vector and for that purpose the scalar product is formed with the topography data taken from the database, in particular the surface normals. Within each individual surface defined by the terrain points, an identical value is calculated. If a surface normal points in the direction of the light incidence vector, that corresponds to reflection of the light at the respective terrain point. Desirably such a terrain point is represented as being light. In a preferred alternative the imaging data are ascertained by simulation of the scalar product. For that purpose the topography data are taken from the database, encoded by a visually perceptible encryption and stored in the form of textures, the extent of which corresponds to that of the respective underlying tile or the region of the surface of the earth. The term texture is used to denote a pattern or a surface that is optically configured. Encoding is effected in such a way that the spatial directions of the surface normals can be separated, in which respect however preferred encoding is effected separately for each spatial direction, that is to say a respective texture is calculated for the x-, y- and z-component of the surface normals. The encoding is identical within each individual surface.

The light incidence data and in particular the light incidence vector are broken down into their spatial components for the blending method in dependence on the direction of incidence of the light, and the proportions of the spatial components are ascertained at the light incidence vector. The representation of a stationary or the current two-dimensional image requires only one single light incidence vector besides the proportions, ascertained therefrom, of the spatial components. All topography data of the current two-dimensional image are then weighted with those proportions. If a surface normal points in the direction of the light incidence vector, that corresponds to reflection of the light at the respective terrain point and, after the encoding operation, that terrain point is represented as being light.

To perform the blending method, the textures describing a surface normal are weighted with the proportions of the spatial components at the current light incidence vector. If for example the light incidence vector involves a large x-component but a small y-component, the texture of the x-component of the surface normals passes into the image with a larger proportion than the texture of the y-component, the textures are blended over each other in weighted relationship. Overblending of the textures can be viewed as mutual superpositioning of the optically configured surfaces, which is to be converted by simple calculating operations such as addition or multiplication. That ‘blending’ is effected in the graphics card, requires a particularly low level of calculating complication and expenditure and therefore advantageously does not load the CPU of the system.

In a further embodiment the orientation of the individual surfaces in the texture data is stored as a color code.

Thus encryption of the items of information stored in the textures, in particular for the orientation of the individual surfaces, is effected in the form of color values which, when using the blending method, can be particularly easily superposed and are thus mixable by addition, whereby the stored items of information can be clearly reproduced. It is possible to use for that purpose a color code, preferably with red, green and blue values. The superpositioning of those colors affords a grey scale image as imaging for the two-dimensional representation.

Advantageously the orientation of the imaging of the two-dimensional image in relation to the orientation of a viewer is tracked, with respect to the three-dimensional topography. In other words, in order to simplify orientation on the part of the pilot on the terrain, the orientation of the imaging of the two-dimensional image, that is to say the digital map, in relation to the orientation of the viewer, is tracked with respect to the three-dimensional topography. Therefore the map representation is always aligned and tracked in the direction of flight of an aircraft.

The representation of terrain on a display unit, for example a navigational display, can also be composed of the data of a plurality of tiles, in which case the representation of the terrain can be stored by textures beyond the imaging surface of the display unit by at least one row of tiles in the memory of the graphics card so that no gaps occur at the edge of the imaging surface when tracking or updating the map representation. The center of the display unit can be correlated with the topography data represented at the center, whereby it is possible to implement unique identification of the topography data at the center by way of the tiles on which they are based. When the aircraft moves beyond the edge of the tile correlated with the center, a fresh correlation can be implemented with the tile that then forms the basis for the centre. In addition, at the row of the tiles previously held beyond the edge of the imaging surface, or the imaging data thereof, the adjoining row of tiles can be processed in accordance with the method and the associated imaging data can be held in the memory of the graphics card. In that way it is possible to track the map representation in the direction of flight.

So that only one single row of tiles or the imaging data thereof are stored beyond the edge of the imaging surface and thus the memory requirement can be reduced, it is possible for the row of tiles held in opposite relationship to the direction of flight, or the imaging data thereof, to be erased from the memory after or during tracking of the tiles in the direction of flight. The data can be transmitted by way of a network or a data bus.

Desirably the light incidence vector is selected in such a way that its direction always points downwardly or inclinedly downwardly, with respect to the orientation of the viewer, in the imaging of the two-dimensional image.

The orientation of the light incidence vector suggests to a viewer illumination of the two-dimensional image ‘from above’. That ‘illumination from above’ of the three-dimensional topography ensures that the human eye perceives the terrain represented in a shadow casting mode is perceived in such a way that elevations are perceived as a raised portion and valleys as a depression. In the case of static illumination, particularly if the illumination were ‘from above’, then by virtue of the intrinsic properties of the human eye and processing of the information in the brain, elevations would be assessed as a depression and valleys as a raised portion. That effect is also referred to as the so-called flip-over or reversal effect.

In order to rule out the viewer being misled by the flip-over or reversal effect, the light incidence vector is also always caused to track the movement of the viewer of the imaging in the terrain in such a way that, in the imaging of the two-dimensional image, the notional illumination by the light incidence vector is effected downwardly or inclinedly downwardly.

In a further configuration of the method the altitude values of the individual surfaces of the topography are stored as additional texture data.

The altitude values of the terrain points, which are stored in the tiles, are encoded in a texture, wherein a single texture with only one component is sufficient for the altitude values. In that way there is the particular advantage that, without an additional method step, the items of altitude information can already be incorporated into the imaging data by ‘blending’ during simulation of the scalar product, and made available to the pilot. The use of an alpha texture is particularly advantageous. However a texture corresponding to the encoding of the surface normals is also possible. Advantageously the additional texture data are stored as alpha values or as color codes.

In that way it is possible to effectively add the additional texture data of the altitude values which are encrypted with the same color code as the other textures to the imaging data in the overblending operation. A particularly advantageous development of the invention provides for a comparison of the vertical position of the viewer of the two-dimensional shaded image over the three-dimensional topography with altitude values of the topography and in the event of conformity or difference the regions of the topography with conforming and/or differing altitude value are identified with at least one visual marking.

For navigation in difficult terrain, for example during the landing approach or in low-level flying, implementation of a comparison of the vertical position of the viewer over the three-dimensional topography, that is to say the flight altitude, with the altitude values of the terrain and the display of conforming or differing values in the two-dimensional representation is meaningful. The comparison of the flight altitude with lower or higher areas can be implemented for example by means of an alpha test. In that case the filter function of a graphics card is used, which selects from the altitude values stored in the alpha texture, those altitude values which are above a given limit value. Such a selectable limit value could be for example the current flight altitude. As a consequence thereof, only the areas that correspond to the flight rule, that is to say which are for example higher than the current flight altitude, would be represented. The use of various limit values also makes it possible to represent steps in the altitude values in one reproduction.

The conforming or differing values can be displayed by at least one visual marking, for example by coloring. Thus for example the terrain elevations can be colored red in the two-dimensional image, which, having regard to safety tolerances, correspond to or are higher than the flight altitude. In that way, possibly using further warning functions such as signal sounds or text messages, the pilot can be warned about surrounding terrain with which the aircraft could collide when maintaining the flight altitude or the flight direction. The visual marking however can also be such that the increasing or decreasing altitude of the elevation in the terrain is displayed by a stepped coloring effect.

In a further development the imaging data of the two-dimensional shaded image are calculated and stored in different levels of resolution. In that way if necessary it is also possible to display higher magnifications of the terrain immediately and to switch over between different magnification stages.

The magnification or detail stage of the two-dimensional image is established by the spacing of adjacent terrain points from each other, such spacing being stored for example in the tiles. To represent different detail stages, each magnification to be represented in respect of the topography data is processed in accordance with the method and then suitably stored.

For representation on the display unit, it is usual to use a constant imaging surface that for example is covered by 1024 pixels. With increasing magnification it is possible for example to zoom from a representation of an imaged terrain which extends over 128×128 nautical miles (nm), over 64×64 nm to 32×32 nm, to a detail stage of the terrain of 16×16 nm. It is possible to switch to and fro without delay between the different magnifications in particular when each detail stage that can be represented is stored. That is desirably effected in a texture pyramid. It has proven to be particularly advantageous if the amount of data in each different detail stage is identical. If therefore the data density of the next higher magnification stage, in comparison with the data density of the preceding magnification stage, is twice as high or the data density is halved when zooming out of the preceding higher degree of magnification. As a consequence thereof the memory requirement can be exactly predicted. In that way the costs can be reduced to the amount that is only absolutely necessary. As described, tracking of the map representation is implemented independently for each magnification.

Other features which are considered as characteristic for the invention are set forth in the appended claims.

Although the invention is illustrated and described herein as embodied in a method and an apparatus for representing a three-dimensional topography, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The single FIGURE of the drawing is a block circuit diagram of an apparatus for the two-dimensional representation of a three-dimensional topography according to the invention.

### DESCRIPTION OF THE PREFERRED EMBODIMENTS

Referring now to the single FIGURE of the drawing in detail, there is shown in the form of a block circuit diagram an apparatus 10 for two-dimensionally representing a three-dimensional topography. The apparatus 10 includes a display unit 11, an image generating device 13 and a control unit 14, wherein the display unit 11 produces an image of a topography processed in accordance with the method, in the form of a two-dimensional shaded image 12.

The image 12 shows a terrain with ranges of hills and valleys in a light-dark representation. In the present example illumination of the topography is simulated by a light incidence vector which points inclinedly downwardly and which is indicated by an arrow 15.

This application claims the priority, under 35 U.S.C. § 119, of German patent application No. 10 2004 040 372.4, filed Aug. 20, 2004; the entire disclosure of the prior application is herewith incorporated by reference.

I claim:

1. A method of two-dimensionally representing a three-dimensional topography, which comprises the steps of:
ascertaining imaging data from topography data describing the three-dimensional topography and from light incidence data vectorially describing a predetermined light incidence, the topography data containing data of individual surfaces and data relating to an orientation of the individual surfaces;
calculating, for each of the individual surfaces, a respective associated texture describing a display of a pattern from the data relating to the orientation;
weighting the texture in dependence on the light incidence data resulting in weighted textures; and
representing the image data as a two-dimensional shaded image, the two-dimensional shaded image of the three-dimensional topography being composed from the weighted textures as the imaging data.

2. The method according to claim 1, which further comprises:
taking respective three spatial components of a surface normal from the data relating to the orientation of the individual surfaces or are calculated and the imaging data for an individual surface are either calculated by forming a scalar product between the surface normal and a light incidence vector or a blending method for weighted overblending of textures is used for simulation of a formation of the scalar product.

3. The method according to claim 1, which further comprises storing the orientation of the individual surfaces in texture data as a color code.

4. The method according to claim 1, which further comprises tracking an orientation of an imaging of the two-dimensional shaded image in relation to an orientation of a viewer with respect to the three-dimensional topography.

5. The method according to claim 4, which further comprises selecting a light incidence vector so that its direction with respect to the orientation of the viewer in the imaging of the two-dimensional shaded image always points downwardly or inclinedly downwardly.

6. The method according to claim 1, which further comprises depositing altitude values of the individual surfaces of the topography as additional texture data.

7. The method according to claim 6, which further comprises storing the additional texture data as alpha values or as color codes.

8. The method according to claim 6, which further comprises:
comparing a vertical position of an observer of the two-dimensional shaded image over the three-dimensional topography to altitude values of the topography and in a case of conformity or difference regions of the topography with conforming and/or differing altitude value are characterized with at least one visual marking.

9. The method according to claim 1, which further comprises:
calculating the imaging data of the two-dimensional shaded image in different resolutions; and
storing the imaging data after the calculating step.

10. An apparatus for two-dimensionally representing a three-dimensional topography, the apparatus comprising:
a display unit;
an image generating device connected to said display unit; and
a control unit connected to said image generating device, said control unit ascertaining imaging data from light incidence data vectorially describing a predetermined light incidence and from topography data describing the three-dimensional topography, said imaging data being represented as a two-dimensional shaded image, the topography data containing data of individual surfaces and data relating to an orientation of the individual surfaces, and for each of the individual surfaces a respective associated texture which describes a display of a pattern is calculated from the data relating to the orientation in dependence on the light incidence data, the texture is weighted in dependence on the light incidence data resulting in weighted data, and the two-dimensional shaded image of the three-dimensional topography is composed from the weighted textures as imaging data.
